(19) United States
(12) Patent Application Publication
(10) Pub. No.: US 2025/0377478 A1
(43) Pub. Date: Dec. 11, 2025

(54) SYSTEM AND METHOD OF ENHANCED STRATIGRAPHIC ZONATION AND CORRELATION OF BASINAL CARBONATE MUDSTONE THROUGH MULTIVARIATE STATISTICAL ANALYSIS

(71) Applicant: KING FAHD UNIVERSITY OF PETROLEUM AND MINERALS, Dhahran (SA)

(72) Inventors: Septriandi Asmaidi CHAN, Dhahran (SA); Abduljamiu Olalekan AMAO, Dhahran (SA); John Dean HUMPHREY, Dhahran (SA); Khalid AL-RAMADAN, Dhahran (SA)

(73) Assignee: KING FAHD UNIVERSITY OF PETROLEUM AND MINERALS, Dhahran (SA)

(21) Appl. No.: 18/734,499

(22) Filed: Jun. 5, 2024

(51) Int. Cl. G01V 20/00; G01V 5/12

(52) U.S. Cl. CPC G01V 20/00; G01V 5/12

(57) ABSTRACT

A system and method for establishing stratigraphic zonation and correlation in basinal mudstone reservoirs including selecting a representative core from wells covering parts of a basin, conducting in-situ high-vertical resolution analyses of the representative core. The high-vertical resolution analysis is conducted using handheld X-ray fluorescence (HH-XRF), at defined intervals to obtain XRF data. In addition, performing PCA and HCPC using the XRF data to generate a plurality of different clusters and validating the different clusters with the representative core to select one cluster. The chemofacies are labeled in the selected cluster using concentrations of three key elements of the different clusters in a ternary diagram. Thereafter, boxplots are generated to determine elements of each chemofacies. Based on that, the distribution of the chemofacies in the well is plotted, and stratigraphic zones are delineated to produce a well-to-well correlation.

### BACKGROUND

### Technical Field

The present disclosure generally relates to stratigraphic zonation and correlation of basinal carbonate mudstones. In particular, the present disclosure relates to a system and a method of enhanced stratigraphic zonation and correlation of basinal carbonate mudstones through multivariate statistical analysis.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In exploration and production of hydrocarbon resources, the characterization of reservoirs plays a pivotal role. The characterization of reservoirs involve the study of various geological formations, including basinal carbonate mudstones. Mudstones are a type of sedimentary rock that are primarily composed of silt and clay-sized particles. They are often found in basins, which are low-lying areas where sediments accumulate over time. The characterization of these mudstones is typically achieved through stratigraphic zonation and correlation. Stratigraphic zonation involves the division of a geological formation into distinct zones based on their physical and chemical properties. These zones are then correlated across different locations to understand the spatial distribution and continuity of the geological formations.

In the exploration and production of hydrocarbon resources, the characterization of basinal carbonate mudstones is a complex task due to their fine-grained nature and inherent heterogeneity. Traditional methods, such as wireline well logs and seismic data, for inferring compositional variability and stratal surfaces for stratigraphic interpretation and correlation may pose challenges. The challenges arise due to lack of resolution of the traditional methods to capture the subtle lithofacies changes within these sedimentary rocks. Consequently, the expertise of mudstone specialists is paramount for accurate stratigraphic interpretation and correlation, as they can identify compositional variability and stratal surfaces that conventional techniques may overlook (see LaGrange, M. T., Konhauser, K. O., Catuneanu, O., Harris, B. S., Playter, T. L. and Gingras, M. K., 2020. Sequence stratigraphy in organic-rich marine mudstone successions using chemostratigraphic datasets. Earth-Science Reviews, 203, p.103137, and Peng, J. and Larson, T. E., 2022. A novel integrated approach for chemofacies characterization of organic-rich mudrocks. AAPG Bulletin, 106(2), pp.437-460)

To address the challenges associated with the fine-grained and heterogeneous nature of mudstones, chemostratigraphic data derived from inorganic geochemical analyses are increasingly utilized. These data are integrated with other datasets to define chemofacies and establish stratigraphic zonation and correlation within mudstone intervals. The application of chemostratigraphy has been particularly successful in the subdivision and correlation of both conventional and unconventional reservoirs, offering a more detailed understanding of the compositional variability and continuity of these geological formations (see Craigie, N. W., 2016. Chemostratigraphy of the Silurian Qusaiba member, Eastern Saudi Arabia. Journal of African Earth Sciences, 113, pp.12-34; El Attar, A. and Pranter, M. J., 2016. Regional stratigraphy, elemental chemostratigraphy, and organic richness of the Niobrara Member of the Mancos Shale, Piceance Basin, Colorado. AAPG Bulletin, 100(3), pp.345-377; Sano, J. L., Ratcliffe, K. T., Spain, D. R., 2013. Chemostratigraphy of the Haynesville Shale. in Hammes and Gale, eds., Geology of the Haynesville Gas Shale in East Texas and West Louisiana, U.S.A.: AAPG Memoir 105, 137-154; Michael, N. A. and Craigie, N. W., 2021. Application of principal component analysis on chemical data for reservoir correlation: A case study from Cretaceous carbonate sedimentary rocks, Saudi Arabia. AAPG Bulletin, 105(4), pp.785-807; Chan, S. A., Bălc, R., Humphrey, J. D., Amao, A. O., Kaminski, M. A., Alzayer, Y. and Duque, F., 2022. Changes in paleoenvironmental conditions during the Late Jurassic of the western Neo-Tethys: Calcareous nannofossils and geochemistry. Marine Micropaleontology, 173, p.102116; Hussain, M., Amao, A. O., Al-Ramadan, K., Babalola, L. O. and Humphrey, J. D., 2022. Unconventional reservoir characterization using geochemical signatures: Examples from Paleozoic formations, Saudi Arabia. Marine and Petroleum Geology, 143, p.105770; Peng, J. and Larson, T. E., 2022. A novel integrated approach for chemofacies characterization of organic-rich mudrocks. AAPG Bulletin, 106(2), pp.437-460; and Larson, T. E., Loucks, R. G., Sivil, J. E., Hattori, K. E. and Zahm, C. K., 2022. Machine learning classification of Austin Chalk chemofacies from high-resolution X-ray fluorescence core characterization. AAPG Bulletin, 107(6), pp.907-927).

Moreover, in study of marine organic-rich mudstone successions, chemostratigraphic proxies based on elemental concentrations and ratios, including major, trace, and rare earth elements, are widely used by researchers. These proxies yield valuable insights for stratigraphic interpretations, shedding light on sediment sources, paleo-redox conditions, and other environmental factors present during the deposition of mudstones. Elements, such as Ca, Mg, Sr, and P are indicative of carbonate mineral enrichments and primary marine phytoplankton productivity, while Si and Al concentrations correlate with the presence of quartz and clay minerals. Elements like Ti, Fe, K, Zr, and Th serve as proxies for detrital or terrigenous input, reflecting the abundance of clay and heavy minerals. Additionally, elements such as Mo, Ni, Cu, V, and S, which are enriched under reducing conditions ranging from anoxic to euxinic, are utilized as redox proxies, further informing the environmental context of mudstone formation.

In addition, the traditional approach to constructing chemostratigraphic frameworks involves the generation and analysis of numerous elemental and elemental ratio profiles for each study section. This process can be daunting and time-intensive, often resulting in hundreds of profiles that require expert interpretation to discern meaningful patterns (see Michael, N. A. and Craigie, N. W., 2021. Application of principal component analysis on chemical data for reservoir correlation: A case study from Cretaceous carbonate sedimentary rocks, Saudi Arabia. AAPG Bulletin, 105(4), pp.785-807).

Accordingly, it is one object of the present disclosure to provide methods and systems for developing a robust analytical method for assessing unconventional hydrocarbon resources. It is a further object of the present disclosure to provide methods and systems for establishing stratigraphic zonation and correlation in unconventional mudstone reservoirs. It is also an object of the present disclosure to improve exploration and production strategies, reduce costs, and increase efficiency. Another object of the present disclosure is to provide a method and system to determine the distribution of vertical and lateral facies. It is also an object of the present disclosure to provide a method and system to makes recommendations for drilling and completion designs. Another object of the present disclosure is to provide a tool for analyzing complex multivariate geological data.

### SUMMARY

In an exemplary embodiment, the present disclosure discloses a method for establishing stratigraphic zonation and correlation in basinal mudstone reservoirs. The method comprises selecting a representative core from wells covering proximal to distal parts of a basin. Further, the method comprises conducting in-situ high-vertical resolution analyses of the representative core. The high-vertical resolution analysis is conducted using handheld X-ray fluorescence (HH-XRF), at defined intervals to obtain XRF data. In addition, the method comprises performing Principal Component Analysis (PCA) and Hierarchical Clustering on Principal Components (HCPC) using the XRF data to generate a plurality of different clusters and validating the different clusters with the representative core to select one cluster. The method further comprises labeling chemofacies in the selected cluster using concentrations of three key elements of the different clusters in a ternary diagram. Thereafter, the method comprises generating boxplots to determine elements of each chemofacies. The method also comprises plotting distribution of the chemofacies in the well and delineating stratigraphic zones. Finally, a well-to-well correlation for each stratigraphic zone is produced.

In an exemplary embodiment, generating the plurality of different clusters includes generating the plurality of clusters representing major lithofacies defined by their chemical composition.

In an exemplary embodiment, the plotting of the different clusters includes plotting an average of normalized concentrations of Ca, Si, and Al on a ternary diagram in assigning labels to the chemofacies.

In an exemplary embodiment, the delineated stratigraphic zones contain diverse lithologies, including sandstone, limestone, chalk, marl, and mixed mudstone, and each stratigraphic zone corresponds to a distinct combination of chemofacies, distinguished by their characteristic chemical composition.

In an exemplary embodiment, producing well-to-well correlations includes establishing a comprehensive well-to-well correlation by cross-referencing the delineated zones.

In an exemplary embodiment, conducting in-situ high-vertical resolution analyses of the representative core is performed during drilling operations.

In an exemplary embodiment, the method of the present disclosure comprises adjusting a borehole position of a drill while drilling in the basin using information of the chemofacies gathered during the drilling.

In an exemplary embodiment, the borehole position is adjusted by adjusting inclination and azimuth angles.

In an exemplary embodiment, the XRF data used to generate the different clusters includes identifying elements selected from the group consisting of Ca, Si, Al, K, Ti, Fe, S, Zr, Sr, Mo, cu, Ni, V, and U.

In an exemplary embodiment, the chemofacies include Chemofacies 1 for chalk/limestone, Chemofacies 2 for marly limestone, Chemofacies 3 for organic-rich siliceous marl, Chemofacies 4 for sandstone, and Chemofacies 5 for mixed mudstone.

In an exemplary embodiment, the distribution of the chemofacies in the well is a vertical distribution of chemofacies.

In an exemplary embodiment, the present disclosure discloses a system for establishing stratigraphic zonation and correlation in basinal mudstone reservoirs. The system comprises a plurality of wells covering proximal to distal parts of a basin. The system further comprises a handheld X-ray fluorescence (HH-XRF) device for conducting in-situ high-vertical resolution analyses of a representative core at defined intervals to obtain XRF data. The system further comprises a processing circuitry configured to perform Principal Component Analysis (PCA) and Hierarchical Clustering on Principal Components (HCPC) using the XRF data to generate a plurality of different clusters and validating the different clusters with the representative core to select one cluster. The processing circuitry is configured to label chemofacies in the selected cluster using concentrations of three key elements of the different clusters in a ternary diagram. The processing circuitry is further configured to generate boxplots to determine elements of each chemofacies. In addition, the processing circuitry is configured to plot a distribution of the chemofacies in the well and delineating stratigraphic zones. The processing circuitry is further configured to produce well-to-well correlations for each stratigraphic zone.

In an exemplary embodiment, the processing circuitry is configured to generate the plurality of different clusters by generating the plurality of clusters representing major lithofacies defined by their chemical composition.

In an exemplary embodiment, the processing circuitry is further configured to plot an average of normalized concentrations of Ca, Si, and Al on a ternary diagram in assigning labels to the chemofacies.

In an exemplary embodiment, the processing circuitry is configured to plots the delineated stratigraphic zones which contain diverse lithologies, including sandstone, limestone, chalk, marl, and mixed mudstone, and each stratigraphic zone corresponds to a distinct combination of chemofacies, distinguished by their characteristic chemical composition.

In an exemplary embodiment, the processing circuitry is further configured to establish a comprehensive well-to-well correlation by cross-referencing the delineated zones.

In an exemplary embodiment, the handheld X-ray fluorescence device conducts in-situ high-vertical resolution analyses of the representative core during drilling operations.

In an exemplary embodiment, the processing circuitry is further configured to adjust a borehole position of a drill while drilling in the basin using information of the chemofacies gathered during the drilling.

In an exemplary embodiment, the processing circuitry is further configured to adjust inclination and azimuth angles of the borehole position.

In an exemplary embodiment, the XRF data used to generate the different clusters includes identifying elements selected from the group consisting of Ca, Si, Al, K, Ti, Fe, S, Zr, Sr, Mo, Cu, Ni, V, and U.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flowchart of a method for establishing stratigraphic zonation and correlation in unconventional mudstone reservoirs, according to certain embodiments.

FIG. 2 is an exemplary graph illustrating generation of clusters using one or more input variables, according to certain embodiments.

FIG. 3 is an exemplary illustration of a ternary diagram depicting labeling of chemofacies, according to certain embodiments.

FIG. 4 is an exemplary illustration of a box plot showing distribution of representative elements of each chemofacies/cluster, according to certain embodiments.

FIG. 5 is an exemplary illustration of a graph depicting a vertical distribution of chemofacies and identified zones, according to certain embodiments.

FIG. 6 is an exemplary illustration of a graph depicting well-to-well correlation across a basin, according to certain embodiments.

FIG. 7 is an exemplary illustration of a handheld X-Ray fluorescence instrument, according to certain embodiments.

FIG. 8 is an exemplary illustration of a perspective view of a handheld X-Ray fluorescence instrument, according to certain embodiments.

FIG. 9 is an illustration of a computing system, according to certain embodiments.

FIG. 10 is an illustration of a non-limiting example of details of computing hardware used in the computing system, according to certain embodiments.

FIG. 11 is an exemplary schematic diagram of a data processing system used within the computing system, according to certain embodiments.

FIG. 12 is an exemplary schematic diagram of a processor used with the computing system, according to certain embodiments.

FIG. 13 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The inherent heterogeneity in mudstone composition and texture often leads to difficulties in characterizing and correlating these rocks using traditional stratigraphic methods. Further, standard wireline well logs and seismic data frequently fail to resolve the fine-scale variations within mudstone sequences, which are pivotal for detailed stratigraphic analysis. Existing chemostratigraphic approaches may not adequately distinguish between chemofacies due to the complex interplay of diagenetic and depositional processes that affect the chemical signatures of mudstones. Moreover, integrating geochemical data with other geological and geophysical datasets can be challenging, often resulting in suboptimal stratigraphic models that do not fully leverage the available data. The existing art in the field of stratigraphic analysis of basinal carbonate mudstones faces several challenges that limit its effectiveness and accuracy. These challenges highlight the demand for an improved approach to stratigraphic analysis that can address the limitations of the existing art and provide a more accurate, non-destructive, and integrated method for analyzing basinal carbonate mudstones.

Aspects of this disclosure are directed to a method and system for or establishing stratigraphic zonation and correlation in basinal mudstone reservoirs. The present disclosure introduces an innovative method for the rapid, efficient, consistent, cost-effective, and nondestructive analysis of mudstone cores and other geological samples.

The present disclosure aims to introduce a novel method that streamlines the analysis of mudstone cores. This method leverages a combination of representative elements from various groups, such as Ca, Si, Al, Fe, Ti, K, Mo, Ni, and Cu, to perform a comprehensive analysis. By applying advanced statistical techniques, specifically Principal Component Analysis (PCA) and Hierarchical Clustering on Principal Components (HCPC), the proposed method facilitates the rapid and efficient establishment of chemofacies, chemostratigraphic subdivisions, and well-to-well correlations. The goal is to provide a consistent, cost-effective, and nondestructive approach to mudstone characterization, thereby enhancing the understanding of these complex geological formations.

The methodology proposed in this disclosure extends beyond the analysis of core samples and is applicable to a diverse array of geological materials, including cuttings and outcrop samples. This versatility makes it an invaluable tool for conducting comprehensive geochemical studies across various contexts, not just for unconventional resource assessment. The robustness and efficiency of the proposed analysis method have the potential to substantially advance our understanding of both conventional and unconventional resources, as well as to aid in mineral exploration. By enabling a more thorough and efficient analysis of geological formations, this inventive approach promises to contribute to the broader field of geosciences and resource management.

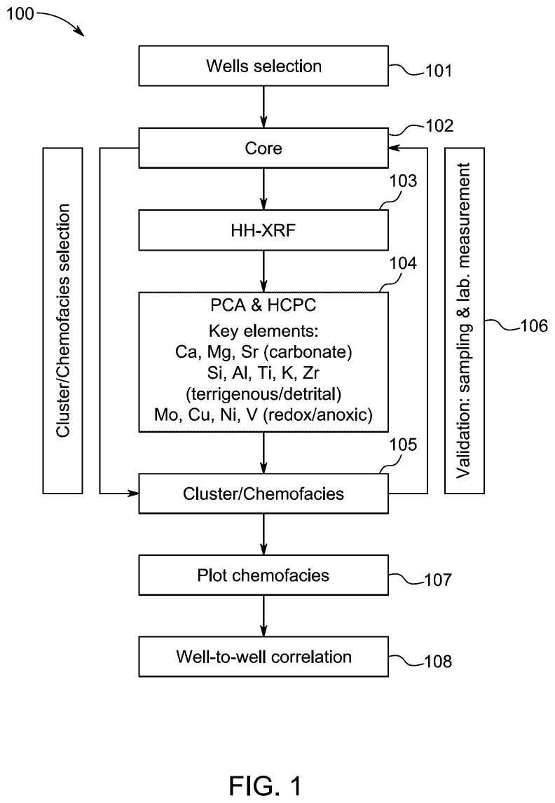

FIG. 1 presents a flowchart illustrating a method 100 for enhanced stratigraphic zonation and correlation of basinal carbonate mudstones, according to the present disclosure. At step 101, the method 100 begins with the selection of a representative core from wells covering the proximal to distal parts of the area/basin. Based on the selection, geological samples such as, core samples, cuttings, and outcrop samples, may be collected, as depicted by step 102. Further, at step 103, the method 100 includes conducting in-situ high-vertical resolution analyses of the representative core, using handheld X-ray fluorescence (HH-XRF), at defined intervals to obtain XRF data. In an embodiment, the geological samples undergo high-resolution Energy Dispersive X-Ray Fluorescence (ED-XRF) to obtain representative elemental data. For example, the geological samples undergo non-destructive ED-XRF scanning. The ED-XRF scanning is performed using a handheld XRF (HH-XRF) instrument. The scanning process is conducted at pre-defined intervals to obtain high-resolution elemental compositions, including both major and trace elements. In an embodiment, the XRF data may include identifying elements selected from the group consisting of Ca, Si, Al, K, Ti, Fe, S, Zr, Sr, Mo, cu, Ni, V, and U. Further, the in-situ high-vertical resolution analyses of the representative core is conducted during drilling operations.

At step 104, the method 100 includes performing Principal Component Analysis (PCA) and Hierarchical Clustering on Principal Components (HCPC) using the XRF data to generate several different clusters and validating the different clusters with the representative core to select one cluster. In an embodiment, processing the XRF data using unsupervised machine learning tools, such as Principal Component Analysis (PCA) is done to reduce the dimensionality of the data and to identify patterns that represent the major variations in the geochemical composition of the samples. Thus, PCA facilitates simplifying the dataset while retaining the core information. Following PCA, Hierarchical Clustering on Principal Components (HCPC) is utilized to classify the samples into distinct chemofacies or clusters, as depicted by step 105. Each cluster represents a major lithofacies defined by their chemical composition. In an embodiment, the method 100 may also include naming each cluster by plotting them in a ternary diagram.

To decide on the number of chemofacies, various statistical criteria such as the silhouette coefficient, gap statistic, or dendrogram analysis may be used. These statistical criteria help in determining the point at which the addition of another cluster does not provide a meaningful increase in the quality of the classification. In an embodiment, based on the PCA and HCPC, there may be 3 to 7 chemofacies or clusters.

As depicted at step 106, the selected chemofacies may then be validated. The validation may include comparing the selected chemofacies with known geological and geochemical data, to ensure that they are representative of distinct geological processes or depositional environments. The outcome of this step is a set of clearly defined and validated chemofacies, each representing a different geochemical signature within the basinal carbonate mudstones.

In addition, the method 100 may include labeling chemofacies in the selected cluster using concentrations of three key elements of the different clusters in a ternary diagram and generating, boxplots to determine elements of each chemofacies.

Subsequently, the method 100 includes at step 107, plotting the distribution of chemofacies within a well to establish chemostratigraphic subdivisions or zones within the geological formation. In an example, plotting of the different clusters includes plotting an average of normalized concentrations of Ca, Si, and Al on a ternary diagram in assigning labels to the chemofacies. The chemostratigraphic subdivisions or zones delineate different stratigraphic zones within the formation. In addition, the delineated stratigraphic zones contain diverse lithologies, including sandstone, limestone, chalk, marl, and mixed mudstone, and each stratigraphic zone corresponds to a distinct combination of chemofacies, distinguished by their characteristic chemical composition. In an implementation, the distribution of the chemofacies in the well is a vertical distribution of chemofacies.

In an embodiment, the method 100 also includes adjusting a borehole position of a drill while drilling in the basin using information of the chemofacies gathered during the drilling. The borehole position is adjusted by adjusting inclination and azimuth angles.

Further, at step 108, these subdivisions are correlated across different wells to achieve a comprehensive stratigraphic correlation. The well-to-well correlations are performed to assess lateral continuity and spatial distribution patterns of lithofacies. In an example, producing well-to-well correlations includes establishing a comprehensive well-to-well correlation by cross-referencing the delineated zones. The chemofacies and stratigraphic framework are integrated with additional geological data, such as well logs and seismic data, to enhance the overall reservoir characterization.

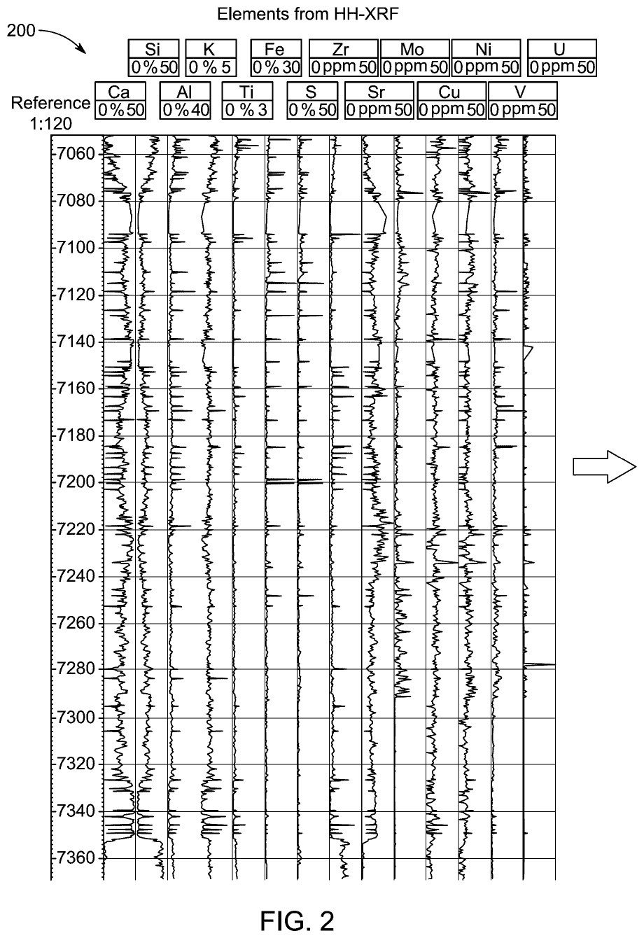

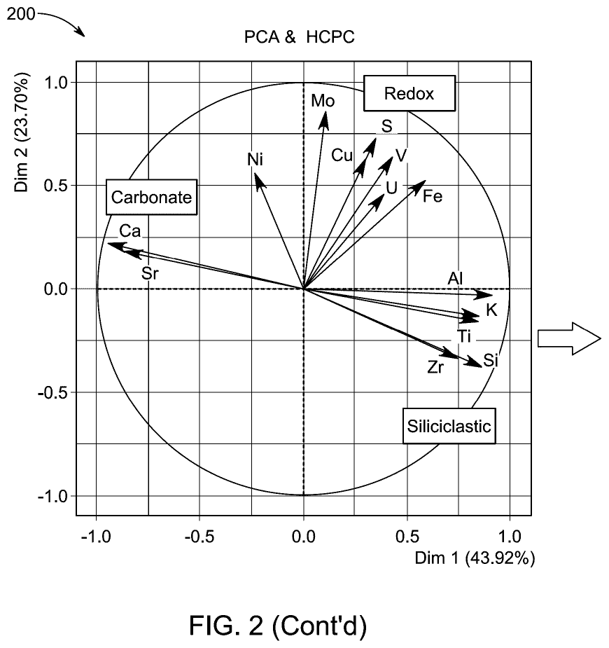

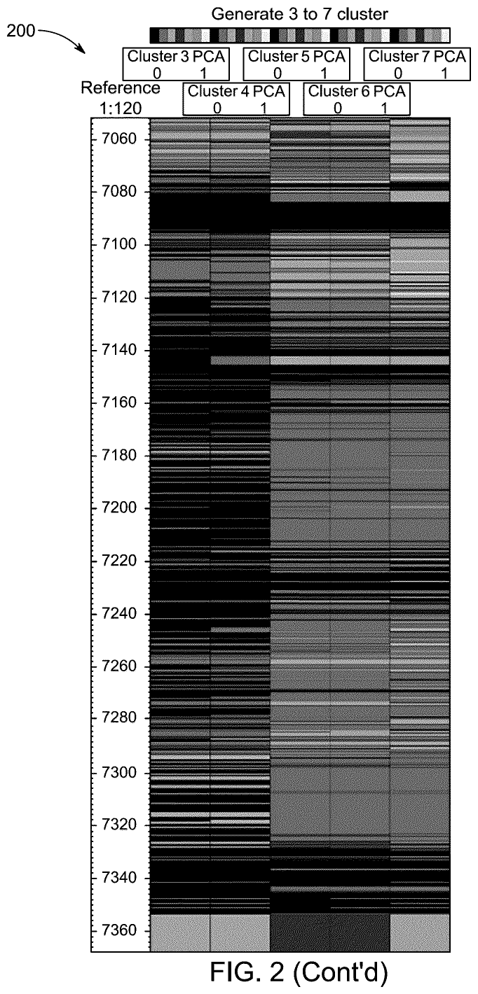

FIG. 2 provides an exemplary graph 200 illustrating the generation of clusters using one or more input variables, according to certain embodiments of the method. The graph 200 visually represents the process by which data is analyzed and grouped into clusters that correspond to distinct chemofacies or geochemical signatures within the geological samples being studied. For example, to generate the clusters, firstly raw geochemical data, such as elemental concentrations from basinal carbonate mudstone samples, is collected and prepared for analysis. The geochemical data is collected using the HH-XRF instrument. For example, a geological sample, such as a mudstone core, cutting, or outcrop sample, is positioned in the ED-XRF device. The geological sample is typically placed on a clean, stable surface within the device to ensure accurate analysis. Thereafter the ED-XRF device emits X-rays towards the geological sample. These X-rays interact with the atoms in the geological sample, causing each element to emit its characteristic secondary (or fluorescent) X-rays. A detector within the ED-XRF device captures the fluorescent X-rays emitted by the elements in the sample. As depicted in FIG. 2, the fluorescent X-rays emitted by the geological sample provides a detailed vertical resolution of major and trace elemental compositions. The major elements (Ca, Mg, Si, Al, Ti, K, Fe, S, P) were reported as weight percent, while trace elements (Mo, Cu, V, Ni, Sr, Cr, Mn, Zr, Zn) were reported as ppm.

Once the raw geochemical data is collected, dimension reduction technique, such as Principal Component Analysis (PCA), is applied on the geochemical data. The PCA simplifies the input data by transforming it into a set of principal components that capture the majority of the variance in the data. For example, each principal component from the set of principal components is associated with a score. The score is calculated for each geological sample, representing the sample's location in the reduced-dimensional space. In addition, a scree plot is generated to visualize the variance captured by each principal component, aiding in the selection of the number of components to retain for analysis. Based on the scree plot, a biplot may be included to display the scores of the samples and the loadings of the elements on the principal components, providing a comprehensive view of the data structure.

Thereafter, a clustering technique, such as Hierarchical Clustering on Principal Components (HCPC), may be applied to the reduced data to form groups based on geochemical similarities. Further, the present disclosure includes determining an optimal number of clusters in which a graphical representation of the method is used to determine the number of clusters, which could include plots or criteria such as the silhouette coefficient or gap statistic. The final output depicting the distinct clusters, each representing a chemofacies, with annotations describing the geochemical characteristics that define each cluster, may then be obtained. As depicted in FIG. 2, the present disclosure describes generation of seven clusters, i.e., cluster 1 to cluster 7.

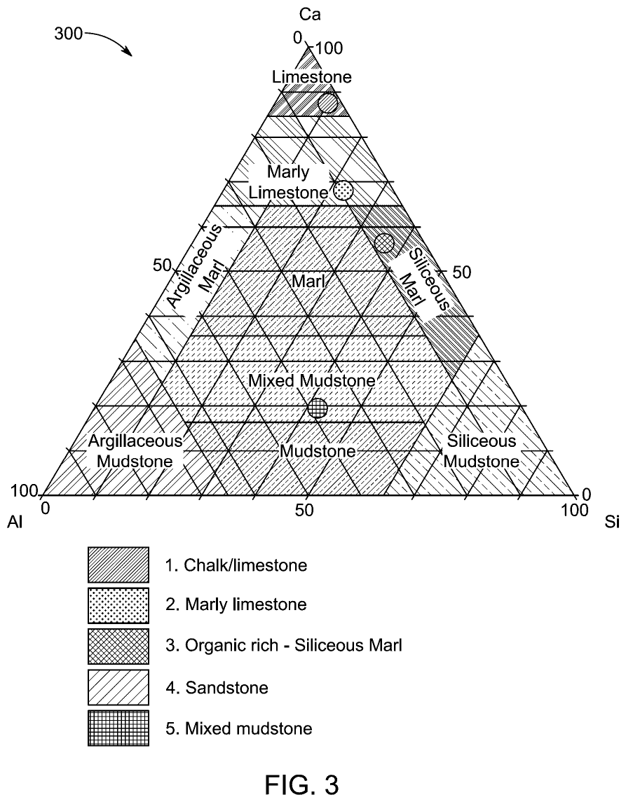

FIG. 3 presents an exemplary illustration of a ternary diagram 300 used for the labeling of chemofacies, in accordance with certain embodiments of the disclosed method. The ternary diagram 300 is a graphical representation commonly used in geochemistry and sedimentology to visualize the proportions of three different variables that sum to a constant value, typically 100 percent. As depicted in FIG. 3, the ternary diagram 300 characterizes and names each chemofacies based on the normalized average values of representative elements, such as calcium (Ca), silicon (Si), and aluminum (Al). The ternary diagram 300 includes three axes, referred to as ternary plot axes. Each ternary plot axes represents one of the three input variables or components (e.g., elemental concentrations or ratios) that define the geochemical composition of the geological samples. Further, the ternary diagram 300 includes data points which is a representation of geochemical data from the geological samples plotted within the ternary diagram 300. Each data point corresponds to the proportions of the three variables for a given geological sample. Further, the ternary diagram 300 includes chemofacies labels which depict distinct regions within the ternary diagram 300 that have been identified as chemofacies. Each chemofacies is labeled according to the geochemical signature represented by the chemofacies. These regions are often delineated based on the clustering analysis described in previous figures. The ternary diagram 300 further includes descriptive text or symbols that provide additional information about the chemofacies, such as the geochemical processes or depositional environments they are associated with.

FIG. 3 serves as a visual aid to demonstrate how chemofacies are distinguished and labeled based on their geochemical signatures within a ternary diagram 300. The ternary diagram 300 helps to convey the compositional relationships between different chemofacies and facilitates the interpretation of geochemical data in the context of geological studies. As depicted in FIG. 3, the identified chemofacies are as follows:

Chemofacies 1 corresponding to chalk/limestone, Chemofacies 2 representing marly limestone, Chemofacies 3 signifying organic-rich siliceous marl, Chemofacies 4 denoting sandstone, and Chemofacies 5 referring to mixed mudstone.

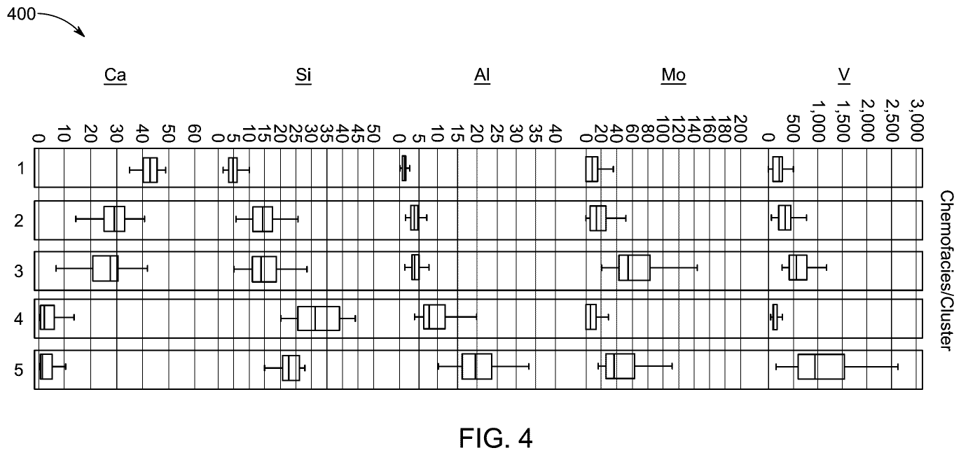

FIG. 4 depicts an exemplary illustration of a box plot 400 that demonstrates the distribution of representative elements for each identified chemofacies or cluster, in accordance with certain embodiments. It would be understood to a person skilled in the art that box plots are statistical representations used to display the distribution of a dataset. The box plot 400 represents the distribution of a particular element across all chemofacies, with a central box indicating the interquartile range and the median value marked inside. Further, the box plot 400 includes whiskers extending from the box to the minimum and maximum values within a reasonable range. In addition, the box plot 400 includes outliers, which are data points that fall outside of the whiskers' range, often marked with dots or asterisks. Further, the box plot 400 includes labels indicating which geochemical element or ratio is being represented by the box plot. As is depicted in FIG. 4, the box plot 400 is associated with a specific chemofacies or cluster, which may be indicated by color-coding, patterning, or grouping within the figure. For example, Chemofacies 1 is characterized by samples with high values for variables Ca and Sr, and low values for variables K, Si, Al, Zr, Ti, Cu, U, Fe, V, and S. Further, Chemofacies 2 consists of individuals sharing high values for variables Cu, Sr, Ca, and K, and low values for variables U, Ti, Fe, Zr, S, Mo, Si, and Al. Chemofacies 3 is characterized by high values for variables Mo, U, Cu, V, S, Fe, and K, and low values for variables Sr, Zr, Ca, and Ti. Chemofacies 4 is comprised of individuals sharing high values for variables Si, Zr, K, Ti, Al, U, and Fe, and low values for variables Ca, Sr, Mo, Cu, V, and S. In addition, Chemofacies 5 exhibits high values for variables Fe, S, V, Al, Ti, Cu, Mo, Zr, and K, and low values for variables Ca and Sr.

Thus, FIG. 4 visually communicates the variability and central tendency of geochemical elements within each chemofacies or cluster. This allows for a quick comparison between the different chemofacies, highlighting the geochemical distinctions that are used to differentiate them.

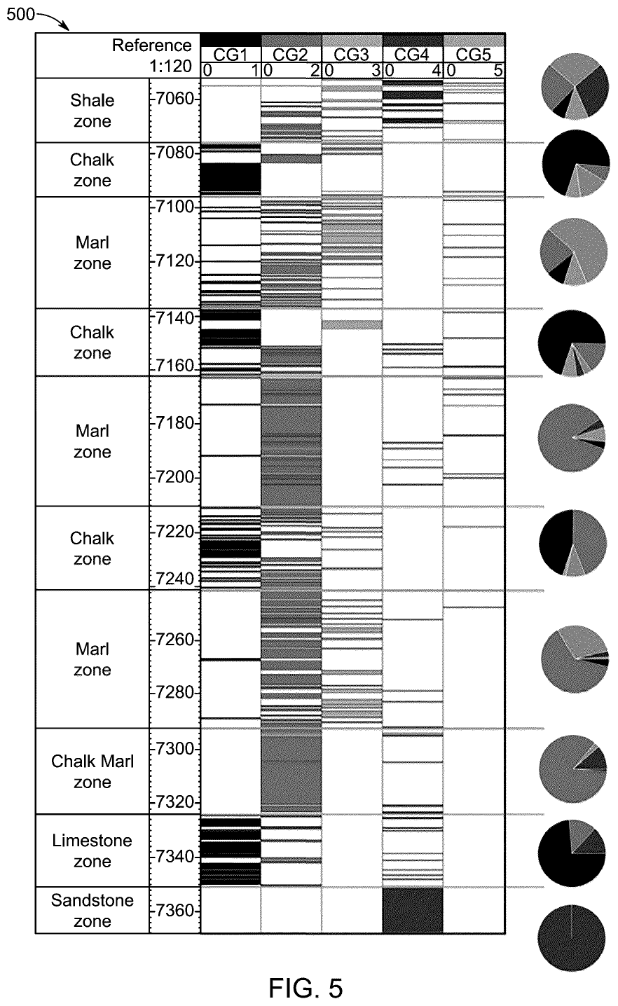

FIG. 5 provides an exemplary illustration of a graph 500 depicting a vertical distribution of chemofacies and identified zones within a geological column, according to certain embodiments. The graph 500 typically represents a stratigraphic section showing the succession of chemofacies over depth or time, which can be correlated to geological events or depositional environments. The graph 500 represents a stratigraphic column which is a vertical representation of the geological layers, with annotations indicating the depth or age of each layer. In addition, the graph 500 includes color-coded or patterned sections within the stratigraphic column that correspond to different chemofacies identified through geochemical analysis. For example, the graph 500 includes multiple columns to depict each of CG1, CG2, CG3, CG4, and CG5. In addition, the graph 500 indicates various zones that demarcate zones of interest within the stratigraphic column, which may represent particular geological events, time periods, or depositional environments. For example, the graph 500 indicates different zones based on presence of different elements across the depth of a well. As depicted in FIG. 5, the various zones may include Shale zone, Chalk zone, Marl zone, Chalk Marl zone, Limestone zone, and Sandstone zone.

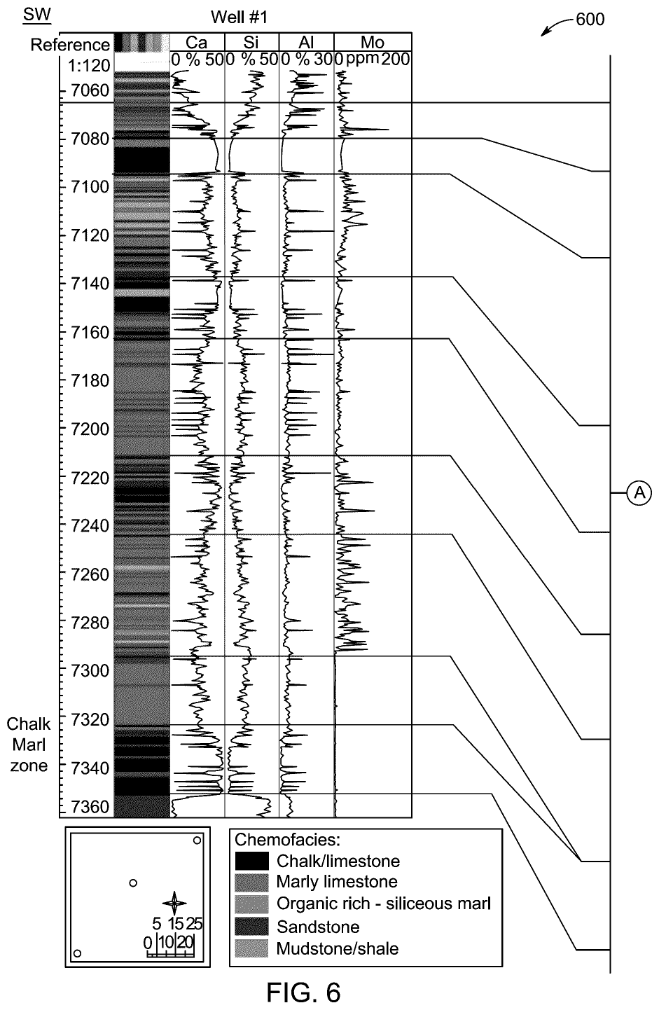

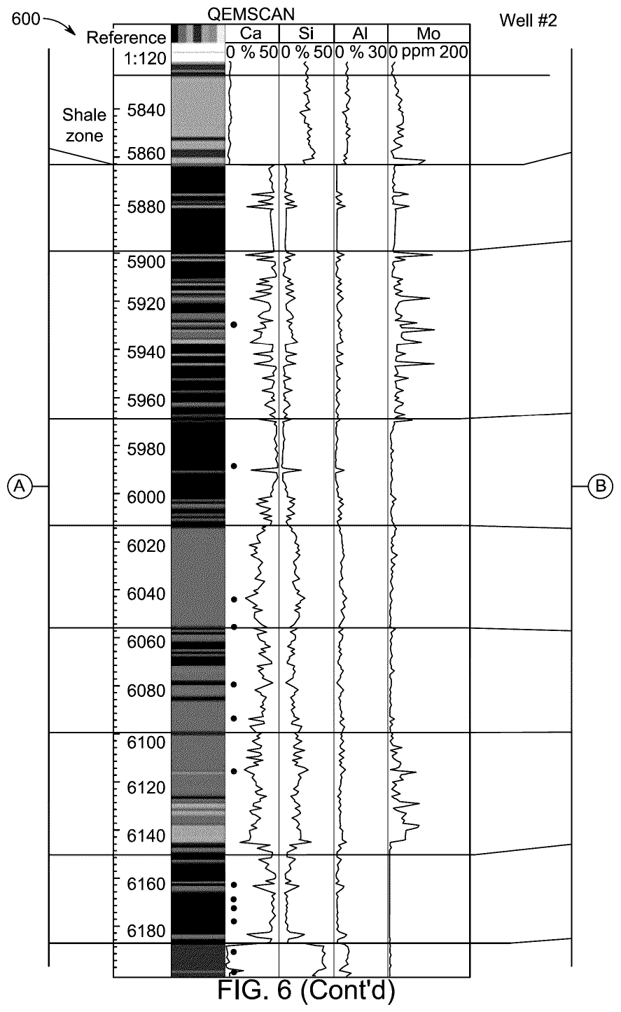

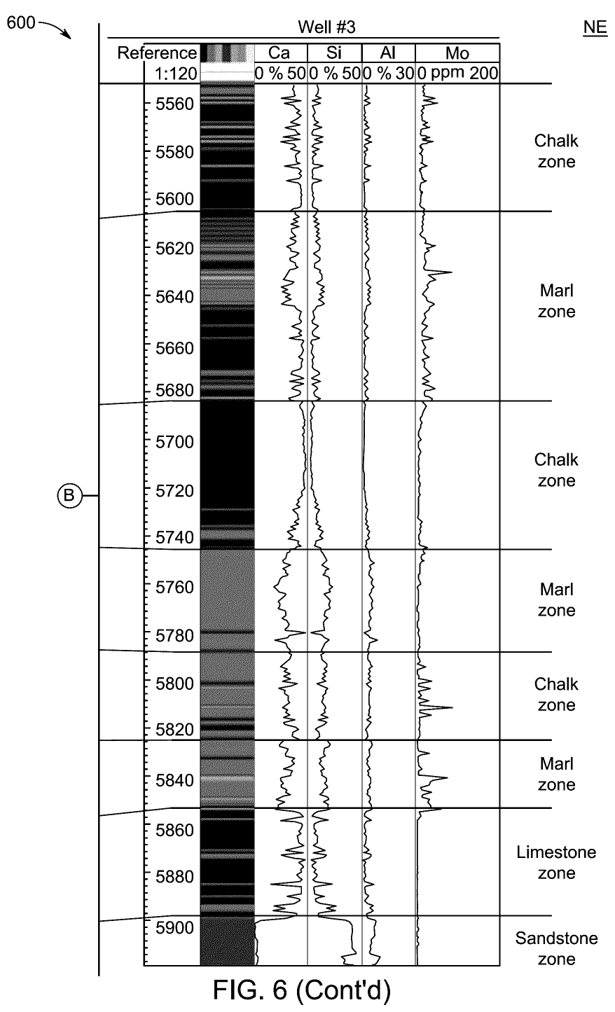

FIG. 6 depicts an exemplary illustration of a graph 600 depicting well-to-well correlation across a basin, according to certain embodiments. The graph 600 demonstrates the lateral continuity and correlation of chemofacies between different well locations within a geological basin for each zone. The Vertical columns in the graph 600 represent the stratigraphic sequences obtained from different wells. Further, the horizontal lines or connectors illustrate the correlation of specific chemofacies or zones between the well logs. The well-to-well correlation is obtained by cross-referencing the identified zones, facilitating the evaluation of lateral continuity and spatial distribution patterns of lithofacies. The graph 600 depicts the identified chemofacies by color-coding, patterns, or symbols within the well logs.

FIG. 7 is an exemplary illustration of a handheld X-Ray fluorescence (XRF) instrument 700, according to certain embodiments. XRF is an acronym for X-ray fluorescence, a process whereby electrons are displaced from their atomic orbital positions, releasing a burst of energy characteristic of a specific element. This release of energy is then registered by the detector in the XRF instrument, which in turn categorizes the energies by element. The XRF instrument 700 is used for in-field geochemical analysis of geological samples, highlighting its components and functionality. The XRF instrument 700 includes a handle 701 having an ergonomic grip designed for comfortable and secure gripping during use. Further, the XRF instrument 700 includes a body portion 702. The body portion 702 is a main structure of the handheld XRF instrument 700, which houses the internal components and provides the form factor for handheld use. The body portion 702 may be made of a durable material to encase the XRF instrument 700, protecting sensitive components from environmental conditions and rough handling. Further, the XRF instrument 700 includes an analysis window (not shown in FIG. 7). The analysis window is that part of the XRF instrument 700 where the geological sample is placed for analysis. The analysis window is typically made of a material that allows X-rays to pass through with minimum absorption or scattering. The XRF instrument 700 also includes a display screen 703 which shows the results of the XRF analysis, device settings, and may also provide a user interface for navigating through different functions of the instrument. In an example, the XRF instrument 700 includes status indicators, such as lights or displays that provide visual feedback on the instrument's status, such as power on, analysis in progress, or battery level. The XRF instrument 700 may further include certain safety features, such as interlocks or shields that ensure the safe operation of the XRF instrument 7000, especially concerning the emission of X-rays.

FIG. 8 is an exemplary illustration of a perspective view of a handheld X-Ray fluorescence instrument 800, according to certain embodiments. The XRF instrument 800 is similar to the XRF instrument 700. FIG. 8 provides a three-dimensional view of the XRF instrument 800. As is evident, the XRF instrument 800 includes an X-Ray source 801 to emit X-rays directed towards the sample for analysis. The emitted X-rays are detected by a detector 802 of the XRF instrument 800. Thus, the present disclosure utilizes a non-destructive handheld ED-XRF spectrometer, such as XRF instrument 700 and 800, to conduct rapid and cost-effective sample analysis. The usage of the handheld ED-XRF spectrometer allows for high-resolution elemental compositions, which facilitate precise chemostratigraphy. In addition, the utilization of XRF scanning as a non-destructive method presents an economical and efficient approach.

Accordingly, the present disclosure employs robust analysis techniques, enabling efficient scanning of multiple cores using XRF within a short timeframe, typically spanning a few days. The integration of chemostratigraphy analysis, which involves the identification of chemofacies and chemostratigraphic zonation, provides a valuable complement to the traditional sedimentological core description-driven facies interpretation. By analyzing elemental data and identifying chemofacies, the present disclosure assists in selecting samples that best represent the reservoir's composition and properties. The present disclosure facilitates the identification of sweet spots within the reservoir, including the recognition of organic-rich facies, as well as the characterization of brittle and ductile zones. The integration of chemostratigraphy and well-log data enables geosteering, a technique used to adjust the trajectory of a wellbore in real-time based on geological information.

Further, the application of PCA and HCPC allows for the identification of distinct lithofacies clusters based on their chemical composition. This method efficiently groups samples into chemofacies, providing a comprehensive understanding of the sedimentary units present in the wells. The utilization of ternary diagrams facilitates the characterization and naming of each chemofacies, thereby enhancing the interpretability of the data, allowing for clear identification and differentiation of lithological units. By establishing a well-to-well correlation based on the identified stratigraphic zones and their corresponding chemofacies, the present disclosure facilitates the evaluation of lateral continuity and spatial distribution patterns of lithofacies. This information is crucial for reservoir characterization and exploration activities, aiding in the optimization of drilling and completion designs and enhancing overall production efficiency.

In addition, the integration of chemostratigraphic analysis with other geological data, such as logs and seismic data, enhances the accuracy and reliability of reservoir characterization. This comprehensive approach provides valuable insights into the complexity of the reservoir, improving exploration strategies and reducing operational risks. The identification of sweet spots within the reservoir, including organic-rich facies and brittle and ductile zones, enables targeted exploration and production activities. The present disclosure assists in the selection of optimal drilling locations, enhancing the efficiency of resource extraction and maximizing hydrocarbon recovery.

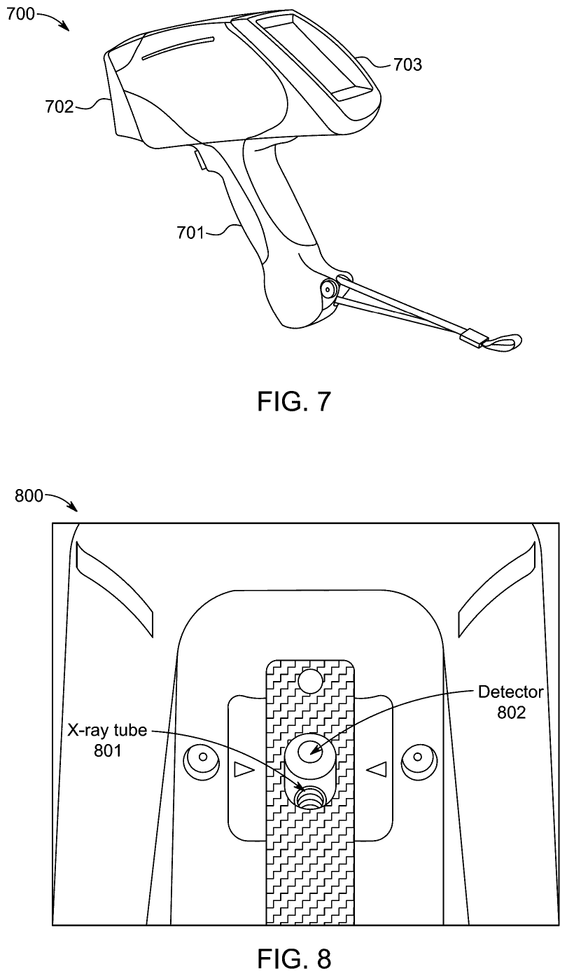

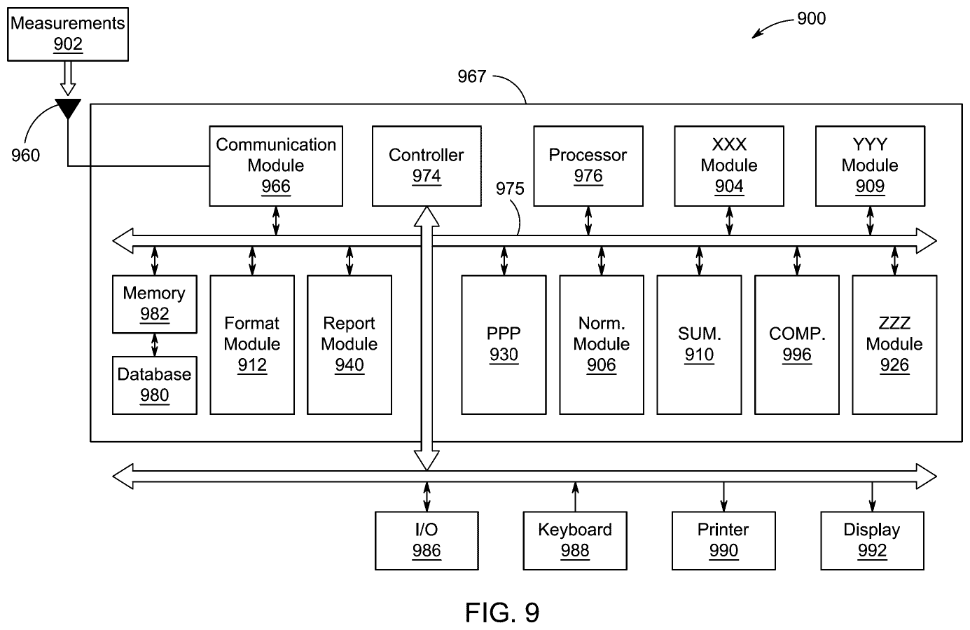

FIG. 9 is an illustration of a computing system 900 (hereinafter referred to as “system 900”), for establishing stratigraphic zonation and correlation in basinal mudstone reservoirs, according to specific embodiments. This figure outlines the hardware and software components of the system 900 used to process, analyze, and store the geochemical data obtained from the handheld XRF instrument. The system 900 is integral to the method, as it enables the interpretation of XRF data to identify chemofacies and perform chemostratigraphic analysis. In an embodiment, the system 900 may receive measurements 902 from the handheld XRF instrument. As may be understood, the measurements 902 pertains to the XRF data. The measurements 902 may be stored in a memory 982 of the system 900. In an example, the memory 982 may include Random Access Memory (RAM) for temporary data storage while programs are running, and storage devices such as Solid State Drives (SSD) or Hard Disk Drives (HDD) for long-term data storage.

Further, the system 900 includes a processor 976 coupled to the memory 982. The processor 976 is configured to assist in execution of computer-readable instructions stored on at least one non-transitory, tangible computer-readable storage medium. The processor 976 may perform Principal Component Analysis (PCA) and Hierarchical Clustering on Principal Components (HCPC) using the XRF data to generate a plurality of different clusters and validating the different clusters with the representative core to select one cluster. In an embodiment, the processor 976 generates the plurality of different clusters by generating the plurality of clusters representing major lithofacies defined by their chemical composition. Further, the processor 976 may label chemofacies in the selected cluster using concentrations of three key elements of the different clusters in a ternary diagram.

The processor 976 may further generate boxplots to determine elements of each chemofacies and plot a distribution of the chemofacies in the well and delineating stratigraphic zones. In an example, the processor 976 is further configured to plot an average of normalized concentrations of Ca, Si, and Al on a ternary diagram in assigning labels to the chemofacies. Accordingly, the processor 976 plots the delineated stratigraphic zones which contain diverse lithologies, including sandstone, limestone, chalk, marl, and mixed mudstone, and each stratigraphic zone corresponds to a distinct combination of chemofacies, distinguished by their characteristic chemical composition. In addition, the processor 976 may produce well-to-well correlations for each stratigraphic zone. In an example, the processor 976 is further configured to adjust a borehole position of a drill while drilling in the basin using information of the chemofacies gathered during the drilling. For example, to adjust the borehole position, the processor 976 is configured to adjust inclination and azimuth angles of the borehole position. The system 900 further includes various Input/Output Devices, such as a keyboard 988, a printer 990, and a display 992

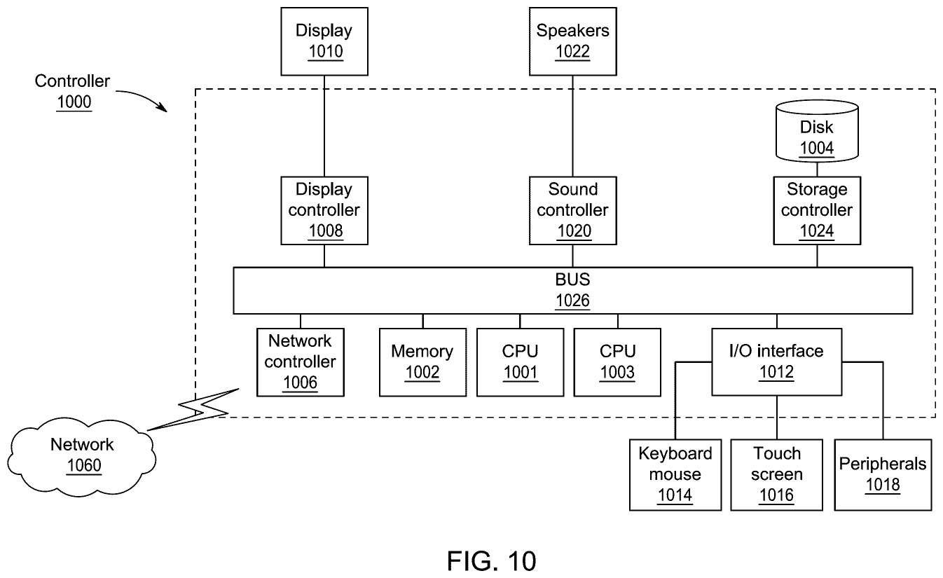

Next, further details of the hardware description of the computing environment of FIG. 9 according to exemplary embodiments is described with reference to FIG. 10. In FIG. 10, a controller 1000 is described is representative of the system 900 of FIG. 9 in which the controller 1000 is a computing device which includes a CPU 1001 which performs the processes described above/below. The process data and instructions may be stored in memory 1002. These processes and instructions may also be stored on a storage medium disk 1004 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 1001, 1003 and an operating system such as Microsoft Windows 7, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1001 or CPU 1003 may be a Xenon or Core processor from Intel of America or an Opteron processor from AMD of America, or may be other processor types that would be recognized by one of ordinary skill in the art. Alternatively, the CPU 1001, 1003 may be implemented on an FPGA, ASIC, PLD or using discrete logic circuits, as one of ordinary skill in the art would recognize. Further, CPU 1001, 1003 may be implemented as multiple processors cooperatively working in parallel to perform the instructions of the inventive processes described above.

The computing device in FIG. 10 also includes a network controller 1006, such as an Intel Ethernet PRO network interface card from Intel Corporation of America, for interfacing with network 1060. As can be appreciated, the network 1060 can be a public network, such as the Internet, or a private network such as an LAN or WAN network, or any combination thereof and can also include PSTN or ISDN sub-networks. The network 1060 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 1000 further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computing device such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the computing device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

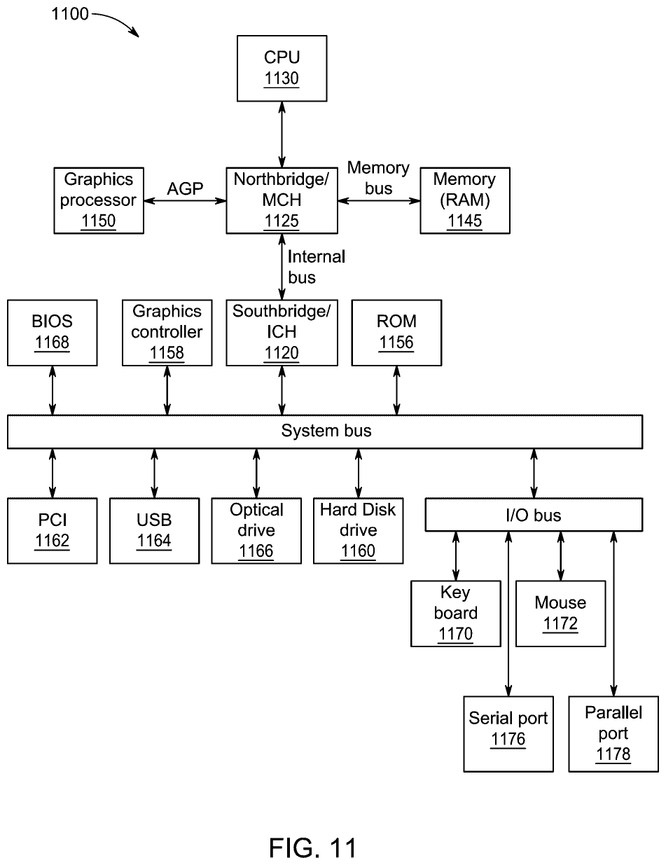

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system, according to certain embodiments, for performing the functions of the exemplary embodiments. The data processing system is an example of a computer in which code or instructions implementing the processes of the illustrative embodiments may be located.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

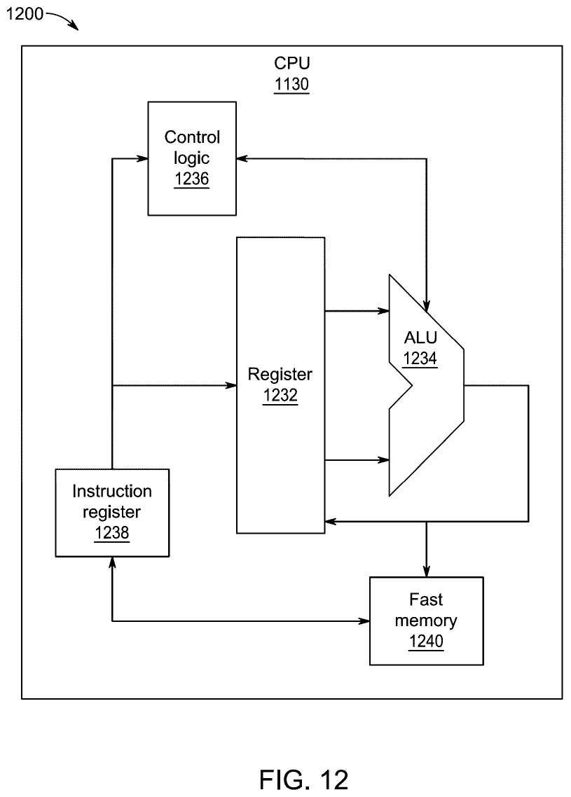

For example, FIG. 12 shows one implementation of CPU 1130. In one implementation, the instruction register 1238 retrieves instructions from the fast memory 1240. At least part of these instructions are fetched from the instruction register 1238 by the control logic 1236 and interpreted according to the instruction set architecture of the CPU 1230. Part of the instructions can also be directed to the register 1232. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an ×86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 888 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices that can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

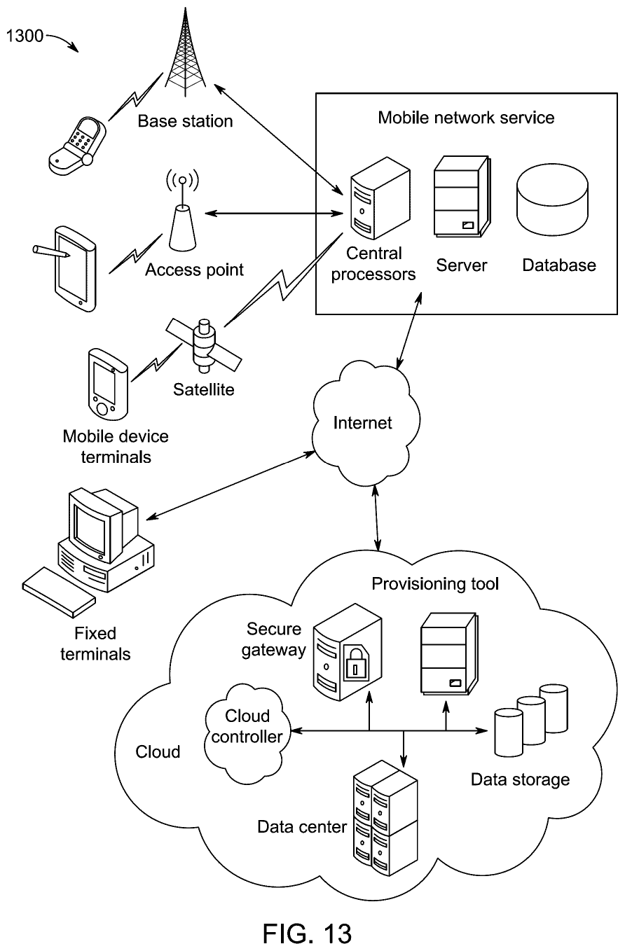

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 13, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A method for establishing stratigraphic zonation and correlation in basinal mudstone reservoirs, comprising:
selecting a representative core from wells covering proximal to distal parts of a basin;
conducting in-situ high-vertical resolution analyses of the representative core by X-ray fluorescence (HH-XRF) at defined intervals to obtain XRF data;
performing, by processing circuitry, Principal Component Analysis (PCA) and Hierarchical Clustering on Principal Components (HCPC) using the XRF data to generate a plurality of different clusters and validating the different clusters with the representative core to select one cluster;
labeling, by the processing circuitry, chemofacies in the selected cluster using concentrations of three key elements of the different clusters in a ternary diagram;
generating, by the processing circuitry, boxplots to determine elements of each chemofacies;
plotting, by the processing circuitry, distribution of the chemofacies in the well and delineating stratigraphic zones; and
producing, by the processing circuitry, a well-to-well correlation for each stratigraphic zone.

2. The method of claim 1, wherein the generating the plurality of different clusters includes generating the plurality of clusters representing major lithofacies defined by their chemical composition.

3. The method of claim 1, wherein the plotting of the different clusters includes plotting an average of normalized concentrations of Ca, Si, and Al on a ternary diagram in assigning labels to the chemofacies.

4. The method of claim 1, wherein the delineated stratigraphic zones contain diverse lithologies, including sandstone, limestone, chalk, marl, and mixed mudstone, and each stratigraphic zone corresponds to a distinct combination of chemofacies, distinguished by their characteristic chemical composition.

5. The method of claim 1, wherein the producing well-to-well correlations includes establishing a comprehensive well-to-well correlation by cross-referencing the delineated zones.

6. The method of claim 1, wherein the conducting in-situ high-vertical resolution analyses of the representative core is performed during drilling operations.

7. The method of claim 6, further comprising adjusting a borehole position of a drill while drilling in the basin using information of the chemofacies gathered during the drilling.

8. The method of claim 7, wherein the borehole position is adjusted by adjusting inclination and azimuth angles.

9. The method of claim 1, wherein the XRF data used to generate the different clusters includes identifying elements selected from the group consisting of Ca, Si, Al, K, Ti, Fe, S, Zr, Sr, Mo, Cu, Ni, V, and U.

10. The method of claim 1, wherein the chemofacies include Chemofacies 1 for chalk/limestone, Chemofacies 2 for marly limestone, Chemofacies 3 for organic-rich siliceous marl, Chemofacies 4 for sandstone, and Chemofacies 5 for mixed mudstone.

11. The method of claim 10, wherein the distribution of the chemofacies in the well is a vertical distribution of chemofacies.

12. A system for establishing stratigraphic zonation and correlation in basinal mudstone reservoirs, comprising:
a plurality of wells covering proximal to distal parts of a basin;
an X-ray fluorescence (HH-XRF) device for conducting in-situ high-vertical resolution analyses of a representative core at defined intervals to obtain XRF data;
processing circuitry configured to:
perform Principal Component Analysis (PCA) and Hierarchical Clustering on Principal Components (HCPC) using the XRF data to generate a plurality of different clusters and validating the different clusters with the representative core to select one cluster,
label chemofacies in the selected cluster using concentrations of three key elements of the different clusters in a ternary diagram,
generate boxplots to determine elements of each chemofacies,
plot a distribution of the chemofacies in the well and delineating stratigraphic zones, and
produce well-to-well correlations for each stratigraphic zone.

13. The system of claim 12, wherein the processing circuitry generates the plurality of different clusters by generating the plurality of clusters representing major lithofacies defined by their chemical composition.

14. The system of claim 12, the processing circuitry further configured to plot an average of normalized concentrations of Ca, Si, and Al on a ternary diagram in assigning labels to the chemofacies.

15. The system of claim 12, wherein the processing circuitry plots the delineated stratigraphic zones which contain diverse lithologies, including sandstone, limestone, chalk, marl, and mixed mudstone, and each stratigraphic zone corresponds to a distinct combination of chemofacies, distinguished by their characteristic chemical composition.

16. The system of claim 12, the processing circuitry further configured to establish a comprehensive well-to-well correlation by cross-referencing the delineated zones.

17. The system of claim 12, wherein the handheld X-ray fluorescence device conducts in-situ high-vertical resolution analyses of the representative core during drilling operations.

18. The system of claim 17, the processing circuitry further configured to adjust a borehole position of a drill while drilling in the basin using information of the chemofacies gathered during the drilling.

19. The system of claim 18, the processing circuitry further configured to adjust inclination and azimuth angles of the borehole position.

20. The system of claim 12, wherein the XRF data used to generate the different clusters includes identifying elements selected from the group consisting of Ca, Si, Al, K, Ti, Fe, S, Zr, Sr, Mo, Cu, Ni, V, and U.
